(19) United States
(12) Patent Application Publication
(10) Pub. No.: US 2011/0116128 A1
(43) Pub. Date: May 19, 2011

(54) IMAGE FORMING SYSTEM WHICH INCLUDES IMAGE PROCESSING DEVICE AND PLURAL IMAGE FORMING DEVICES

(75) Inventor: Takeshi TAMADA, Toyohashi-shi (JP)

(73) Assignee: Konica Minolta Business Technologies, Inc., Tokyo (JP)

(21) Appl. No.: 12/917,246

(22) Filed: Nov. 1, 2010

(30) Foreign Application Priority Data
Nov. 17, 2009 (JP) 2009-261418

(51) Int. Cl. G06F 3/12

(52) U.S. Cl. 358/1.15

(57) ABSTRACT

An image forming system includes MFPs and a PC. A control unit in the PC, on receipt of information on a print job, transmits it to each MFP. A CPU in each MFP checks an operating state, a fixing roller temperature, and others in the MFP, calculates power consumption required for executing the print job on the basis of the machine conditions of the MFP and the information on the print job, and transmits the calculation result to the PC. The control unit in the PC displays the required power calculated in each MFP. This allows a user to select an MFP for executing the print job, taking into consideration the required power in each MFP. Accordingly, the image forming device for use in printing can be specified in accordance with the states of the individual image forming devices, so that power saving can be promoted more effectively.

This application is based on Japanese Patent Application No. 2009-261418 filed with the Japan Patent Office on Nov. 17, 2009, the entire content of which is hereby incorporated by reference.

### BACKGROUND OF THE INVENTION

1. Field of the Invention

The present invention relates to an image forming system, and more particularly to an image forming system provided with image forming devices which form images using a heat fixing function.

2. Description of the Related Art

Some electrophotographic image forming devices (such as a multi function peripheral (MFP) provided with the scanner function, facsimile transmitting/receiving function, copying function, function as a printer, data communicating function, and server function, a facsimile machine, a copier, a printer such as a laser beam printer (LBP), and the like) form images using a heat fixing function. In the image forming device having the heat fixing function, electric power is consumed largely by the heat fixing function.

In performing the heat fixing function, heat is generated by a heat source which is provided in a fixing unit. During the heat fixing process, a heat roller and other components in the fixing unit are controlled such that they are kept at an approximately constant temperature. When the image forming device is in a standby state, the heat roller and the other components are controlled such that they are kept at a predetermined temperature. This allows the image forming device to perform a print job quickly in response to a print instruction from a user. On the other hand, when the image forming device is in a sleep state, the heat source in the fixing unit is turned off to save energy. In the case where the image forming device in the sleep state receives a print instruction, the device starts heating the fixing unit and performs the print job only after the temperature of the fixing unit has risen to a sufficient level.

Document 1 below discloses a system provided with printers, in which a host computer acquires one of a sleep state, a print standby state, and a printing state for each of the printers, and outputs print data in accordance with the state of each printer. In selecting a printer to be used, the system gives a higher priority to the printer in the print standby state than to the printer in the sleep state, thereby suppressing the power consumption in the system as a whole.

Document 2 below discloses an image forming device in which, when a print output is completed, the amount of electric power consumed by a single print operation or the electricity cost therefor is displayed on a display unit of the image forming device, or such information is transmitted to the terminal device from which the job data was received.
[Document 1] Japanese Patent Application Laid-Open No. 8-137637
[Document 2] Japanese Patent Application Laid-Open No. 2006-039443

Recently, with advancement in information technology, it is increasingly the case that a plurality of image forming devices connected to a same network are used in a room in which there are a plurality of users. In such a case, the plurality of image forming devices may be in different states from each other, which may cause power consumption to increase or decrease depending on which image forming device is used to execute a same print job. Therefore, in order to decrease power consumption, it is important that an image forming device can be selected with an awareness of energy conservation.

To this end, the system disclosed in Document 1 above for example is configured to use a printer which is already in the print standby state for printing, and not to use a printer in the sleep state. This prevents an increase in number of the printer in the print standby state consuming relatively large power, thereby saving power.

With the system disclosed in Document 1, however, there is a limit in energy conservation. In the case where two or more image forming devices are in the same operating state, the system cannot determine which one should be used to save more power. Even in the sleep state, there will be a great difference in amount of power required for executing a job between the case where the image forming device is relatively cool and the case where the device is relatively warm.

For example, in the case of printing one page in color by an image forming device in the sleep state, required power estimated power consumption is about 6.8 W for a cool device, while it is about 3.9 W for a warm device. Thus, in the case where a plurality of image forming devices are in the same state, it is not possible to accurately determine how much energy can be saved for each of the devices. If a relatively cool device is selected for use, it will consume that power which could have been saved using a relatively warm device, in which case energy saving cannot be achieved.

It is noted that the image forming device disclosed in Document 2 above aims at encouraging a user of the image forming device to pay more attention to power saving. Document 2 provides no solution to the above-described problems.

### SUMMARY OF THE INVENTION

The present invention has been accomplished to solve the foregoing problems, and an object of the present invention is to provide an image forming system which enables an image forming device for use in printing to be specified in accordance with the states of individual image forming devices, to promote power saving more effectively.

To achieve the above object, according to an aspect of the present invention, an image forming system includes a plurality of image forming devices and an image processing device. Each of the plurality of image forming devices has a heat fixing function using a fixing device, and includes a first detecting unit configured to detect a temperature of the fixing device, a recognizing unit configured to recognize an acceptable print job, a calculating unit configured to calculate power consumption that will be required for executing the print job recognized by the recognizing unit on the basis of the temperature detected by the first detecting unit, and an output unit configured to perform an output of output information in accordance with a calculation result by the calculating unit. The image processing device causes an image forming device to execute a print job, and includes an acquiring unit configured to acquire information on power consumption that will be required for executing the print job in each of the plurality of image forming devices with which the image processing device is communicable, and a selecting unit configured to select the image forming device that is suitable for executing the print job on the basis of the information on the power consumption acquired by the acquiring unit, wherein the image processing device causes the image forming device selected by the selecting unit from among the plurality of image forming devices to execute the print job.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of an MFP according to a first embodiment of the present invention;

FIG. 2 is a sectional side view showing a hardware configuration of a printer unit;

FIG. 3 is a block diagram schematically showing a configuration of an image forming system;

FIG. 4 is a flowchart illustrating the operations performed in the image forming system;

FIG. 5 shows an example of a required power calculation table;

FIG. 6 shows an example of the content displayed on a display device in a PC;

FIG. 7 is a flowchart illustrating the operations performed in the image forming system according to a second embodiment;

FIG. 8 shows an example of a required time calculation table;

FIG. 9 shows an example of the content displayed on the display device according to the second embodiment;

FIG. 10 is a flowchart illustrating the operations performed in the PC according to a third embodiment; and

FIG. 11 shows an example of the content displayed on the display device according to the third embodiment in the state where priority modes have been set.

### DESCRIPTION OF THE PREFERRED EMBODIMENTS

Hereinafter, embodiments of an image forming system according to the present invention will be described.

An image forming system includes an image forming device and an image processing device which causes the image forming device to execute a print job.

The image forming device is a multi function peripheral (MFP) provided with the scanner function, copying function, function as a printer, facsimile transmitting/receiving function, data communicating function, and server function. With the scanner function, an image is read from a document which has been set, and stored in a storage medium such as a hard disk drive (HDD). With the copying function, the image is printed on a sheet of paper or the like. With the function as a printer, on receipt of a print instruction from an external terminal, an image is printed on a sheet of paper on the basis of the instruction. With the facsimile transmitting/receiving function, facsimile data is received from an external facsimile machine or the like and stored in a HDD or the like. With the data communicating function, the image forming device transmits data to or receives data from an external device connected thereto. The server function allows a plurality of users to share, e.g., data stored in a HDD.

The image processing device is a personal computer (PC) communicatively connected to the image forming device. The image processing device is provided with a print instruction function. With the print instruction function, the image processing device transmits a print job to the image forming device on the basis of an operation performed by a user, for example.

### First Embodiment

Firstly, an MFP (an example of an image forming device) used for the image forming system according to a first embodiment will be described.

### [Configuration of MFP]

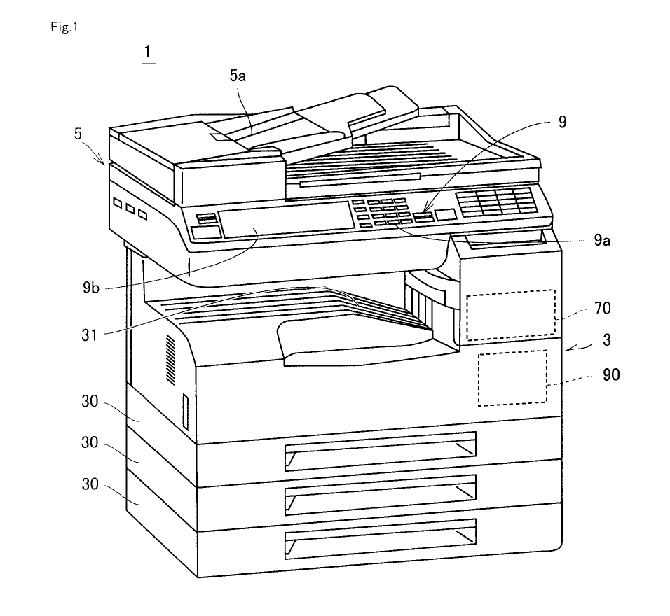

Referring to FIG. 1, an MFP 1 includes a printer unit 3, a scanner unit 5, an operation unit 9, a paper cassette 30, a catch tray 31, a control unit 70, and a power supply unit 90.

MFP 1 has three paper cassettes 30, which may be mounted with sheets of different sizes (for example, B5 size, A4 size, and A3 size). Paper cassettes 30 are arranged in the lower portion of MFP 1 so as to be removable from the housing of MFP 1. During printing, the sheets of paper stored in paper cassettes 30 are fed, one by one, from paper cassette 30 to printer unit 3. It is noted that the number of paper cassettes 30 is not restricted to three; it may be less than three or more than three.

Catch tray 31 is arranged in the housing of MFP 1, above the portion where printer unit 3 is housed and below the portion where scanner unit 5 is arranged. A sheet on which an image has been formed by printer unit 3 is discharged from within the housing onto catch tray 31.

Power supply unit 90 is arranged inside the housing of MFP 1. Power supply unit 90 is connected to a commercial power source. Power supply unit 90 supplies electric power from the commercial power source to control unit 70, printer unit 3, and other components.

Operation unit 9 is arranged on top of MFP 1. Operation unit 9 includes a plurality of operation buttons 9a which can be pressed and operated by a user. Operation unit 9 also includes a display panel (an example of a display unit) 9b. Display panel 9b may be, for example, a liquid crystal display (LCD) provided with a touch panel.

Display panel 9b displays an instruction menu for a user, information on an acquired image, and other information so that a user can recognize them. Display panel 9b also displays operation buttons for accepting a touch operation by a user. Furthermore, display panel 9b displays a login screen, and information stored in MFP 1. Display panel 9b is controlled by control unit 70 to provide such display.

Operation unit 9 accepts inputs of various kinds of instructions as well as data including characters and/or numerical characters in accordance with user's operations via operation buttons 9a and display panel 9b. Operation unit 9, in response to a user's operation of operation button 9a or display panel 9b, transmits an operation signal or a predetermined command corresponding to the operation, to control unit 70. That is, a user can operate operation unit 9 to cause MFP 1 to perform various operations.

Printer unit 3 forms an image on a sheet of paper by electrophotography using a head fixing function, as will be described later. Printer unit 3 is configured to be able to combine images in four colors by using a so-called rotary system, to thereby form a color image on a sheet of paper.

Scanner unit 5 is arranged on top of the housing of MFP 1. Scanner unit 5 has an auto document feeder (ADF) 5a. Scanner unit 5 performs the above-described scanner function to read a document in an optical manner to thereby acquire image data. Specifically, scanner unit 5 uses a contact image sensor to scan a document arranged on a transparent platen glass so as to read it as image data. Furthermore, scanner unit 5 uses ADF 5a to sequentially take in a plurality of pages of documents set in a document tray, and reads image data therefrom by the contact image sensor.

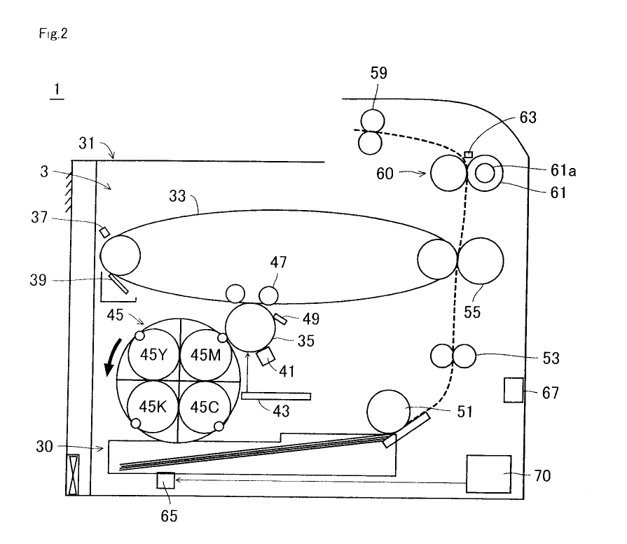

FIG. 2 is a sectional side view showing a hardware configuration of printer unit 3.

MFP 1 is a so-called “four cycle machine”. Referring to FIG. 2, printer unit 3 includes an intermediate transfer belt 33, a photoreceptor drum 35, a development rack unit 45, a transfer roller 55, a fixing unit (an example of a fixing device) 60, and other components. Furthermore, MFP 1 includes a sensor unit (an example of a second detecting unit) 67 and others in addition to the above-described components.

A belt cleaner 37 and an intermediate transfer blade 39 are arranged for intermediate transfer belt 33. Intermediate transfer blade 39 is configured to contact intermediate transfer belt 33 so as to remove toner residuals on intermediate transfer belt 33.

Photoreceptor drum 35 is arranged in the proximity of intermediate transfer belt 33. An electrifying device 41, an exposure unit 43, the development rack unit 45, an opposite roller 47, a cleaner 49, and other components are arranged surrounding photoreceptor drum 35.

Electrifying device 41 electrifies the surface of photoreceptor drum 35. Exposure unit 43 exposes an image pattern onto photoreceptor drum 35. Opposite roller 47 and photoreceptor drum 35 sandwich intermediate transfer belt 33 therebetween. Opposite roller 47 performs primary transfer of a toner image, formed on photoreceptor drum 35, onto intermediate transfer belt 33. Cleaner 49 removes toner residuals from the surface of photoreceptor drum 35.

Development rack unit 45 is mounted with four cartridges 45C, 45M, 45Y, and 45K corresponding to the respective colors of C, M, Y, and K. Cartridges 45C, 45M, 45Y, and 45K are each composed of toner, a developing roller that uses that toner for development, and other components.

Development rack unit 45 is rotatable, as shown by an arrow in FIG. 2. During image forming, control unit 70 drives a motor of a drive unit 65 or the like to rotate development rack unit 45, so as to cause cartridges 45C, 45M, 45Y, and 45K to sequentially move to a development position facing photoreceptor drum 35. This causes a toner image to be formed (or, developed) on photoreceptor drum 35 on which a latent image had been formed by exposure unit 43.

Fixing unit 60 has a heat roller 61, a heater lamp 61a which is arranged within heat roller 61, and a temperature sensor (an example of a first detecting unit) 63. Fixing unit 60 operates under the control of control unit 70. As heater lamp 61a is energized, the surface of heat roller 61 is heated. Temperature sensor 63 measures the temperature of heat roller 61 to thereby detect the temperature of fixing unit 60. Control unit 70 turns on/off heater lamp 61a, on the basis of the temperature of fixing unit 60 detected by temperature sensor 63, to thereby control fixing unit 60.

In the image forming operation, fixing unit 60 is kept at a predetermined fixing temperature by the heat generating from heater lamp 61a. In the fixing process, a sheet on which a toner image has been transferred is sandwiched between and transported by heat roller 61 and a roller opposing the same. During this time, the sheet is heated and pressed by heat roller 61, so that the toner is fixed on the sheet, whereby an image is formed on the sheet.

Sensor unit 67 detects a temperature inside MFP 1 (an inside temperature) and a temperature around MFP 1 (a surrounding temperature). It is noted that sensor unit 67 may detect either one of the temperature inside MFP 1 and the temperature around MFP 1.

Control unit 70 controls MFP 1 to perform an image forming operation. The image forming operation is performed in the following manner.

Firstly, feed rollers 51 and 53 are rotated to feed a sheet. The sheet is transported, one by one, from paper cassette 30 to transfer roller 55.

Printer unit 3 forms a toner image on photoreceptor drum 35 through the processes of electrification, exposure, and development. The toner image thus formed is transferred to intermediate transfer belt 33 using opposite roller 47. This operation is performed sequentially for each color of C, M, Y, and K, whereby the toner images of the four colors are superposed on one another on intermediate transfer belt 33. Transfer roller 55 presses the sheet transported as described above onto the toner image formed on intermediate transfer belt 33, whereby the four-color toner image is transferred onto the sheet (secondary transfer).

It is noted that intermediate transfer belt 33 and transfer roller 55 are kept away from each other while the toner images of four colors are being transferred onto intermediate transfer belt 33. Once the transfer of the toner images of four colors onto the intermediate transfer belt 33 has been completed, transfer roller 55 presses a sheet onto intermediate transfer belt 33 by the time when a front end of the transferred toner image reaches transfer roller 55. As a result, the toner image is transferred to the sheet. Furthermore, when a rear end of the toner image transferred onto intermediate transfer belt 33 has passed belt cleaner 37, intermediate transfer blade 39 is pressed onto intermediate transfer belt 33. This scrapes off toner residues on intermediate transfer belt 33, thereby enabling another toner image to be formed on intermediate transfer belt 33.

The sheet on which the toner image has been transferred by transfer roller 55 is subjected to the fixing process in fixing unit 60 before being discharged by a discharge roller 59.

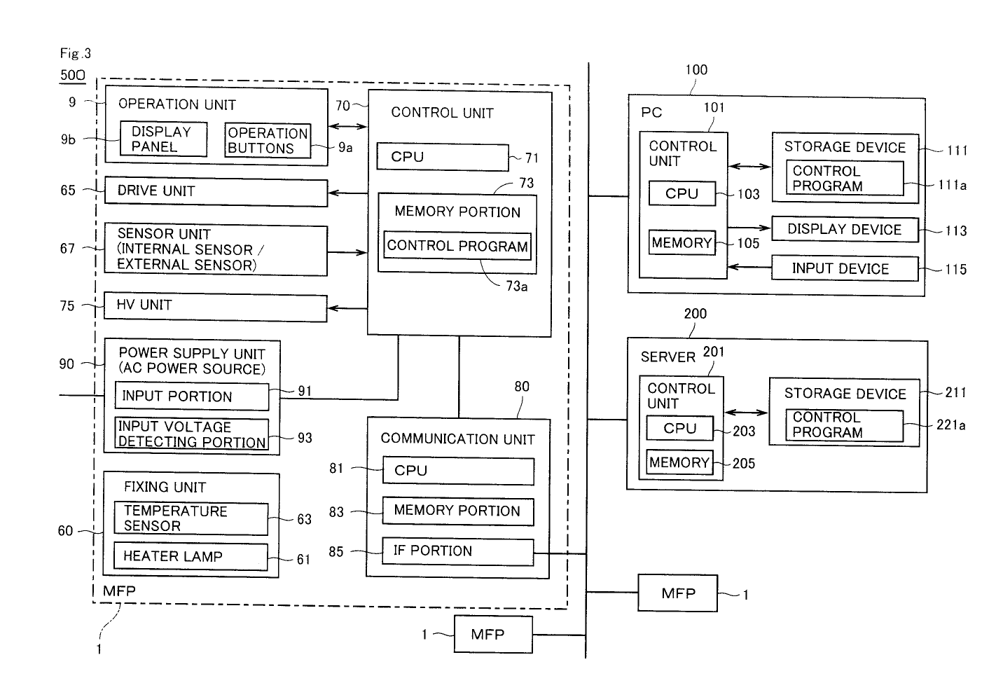

FIG. 3 is a block diagram schematically showing a configuration of an image forming system 500.

Firstly, description of the configuration of MFP 1 will be continued. MFP 1 includes a high voltage (HV) unit 75 and a communication unit (an example of a communication unit) 80 in addition to the above-described components.

Referring to FIG. 3, communication unit 80 includes a CPU 81, a memory portion 83, and an interface (IF) portion 85. IF portion 85 connects MFP 1 to a network such as a local area network (LAN) to enable MFP 1 to communicate with an external device which is connected to the network. CPU 81 uses memory portion 83 and the like to perform the communication. IF portion 85 is connected to the network via a connection cable, for example, to control the communication. It is noted that IF portion 85 may be connected to the network in a wireless manner. Memory portion 83 is made up of storage media such as a ROM and a RAM.

Control unit 70 includes a CPU 71, a memory portion 73, and other components. Control unit 70 is connected, via a system bus or the like, to operation unit 9, drive unit 65, sensor unit 67, HV unit 75, communication unit 80, and other components. Control unit 70 has various functions including a calculating function, a storage function, and a communication function. Control unit 70 reads input information from operation unit 9, for example, to perform various processes, and controls an operation of each unit in MFP 1. Control unit 70 uses sensor unit 67 and other sensors to detect operating conditions and statuses of printer unit 3, and drives and controls drive unit 65 and the like.

Memory portion 73 is made up of storage media such as a ROM and a RAM. It is noted that memory portion 73 may have a mass storage such as a hard disk drive (HDD).

Memory portion 73 stores a control program 73a and other data which are used for MFP 1 to perform a predetermined operation. Memory portion 73 further stores data which is necessary for control unit 70 to perform control program 73a and the like. Memory portion 73 may also store various control programs, function setting data for MFP 1, and the like.

Power supply unit 90 is connected to a commercial power source. Power supply unit 90 includes an input portion 91 and an input voltage detecting portion (an example of a third detecting unit) 93. Input portion 91 converts alternating current input from the commercial power source into direct current, so as to output the converted current to each unit in MFP 1. Input voltage detecting portion 93 detects an input voltage of MFP 1, or, an AC input voltage value input into input portion 91. The information on the AC input voltage value detected by input voltage detecting portion 93 is transmitted to control unit 70 to be stored in memory portion 73 or the like.

HV unit 75 transforms the voltage of the direct current output from input portion 91 so as to output the direct current of a predetermined high voltage. The high-voltage current output from HV unit 75 is used, for example, in printer unit 3 for forming an image.

### [Image Forming System]

Hereinafter, image forming system 500 according to the present embodiment will be described. MFP 1 is used for image forming system 500. Image forming system 500 is composed of MFP 1, a personal computer (PC) (an example of an image processing device, an example of an external device) 100 operated by each user, a server (an example of a management device, an example of an external device) 200, and the like, which are connected with each other via a network such as a LAN. Image forming system 500 includes a plurality of MFPs 1. It is noted that image forming system 500 may include a plurality of PCs 100 and servers 200 each connected to a network. The image forming system does not necessarily have to be provided with PC 100 or server 200.

### [Configuration of PC 100]

Referring to FIG. 3, PC 100 includes a control unit 101, a storage device 111, a display device (an example of a display unit) 113, and an input device 115. Control unit 101 has a CPU 103 and a memory 105. Memory 105 is for example a RAM. Memory 105 functions as a main storage device. PC 100 is communicatively connected to a network.

Storage device 111 is an auxiliary storage device such as a HDD. Storage device 111 may store various control programs 111a to be executed in control unit 101, document data, and other data. Control programs 111a include an application program for editing document data, for example. Control programs 111a also include a printer driver for communicating with MFP 1 via a network to issue an instruction to form an image to MFP 1.

Display device 113 is for example a liquid crystal display, which, under the control of control unit 101, displays an image so as to be recognizable by a user. Input device 115 includes a keyboard and/or a mouse, and issues an instruction to control unit 101 in accordance with an operation by a user. That is, a user can use display device 113 and/or input device 115 to perform various jobs by utilizing PC 100.

Control unit 101 is able to drive a printer driver on the basis of an instruction from a user, for example, so as to issue various instructions to MFP 1. Specifically, control unit 101 is able to instruct MFP 1 to form an image based on document data, or use scanner unit 5 to read a document or the like as document data.

### [Configuration of Server 200]

According to the present embodiment, server 200 has a file server function of storing various kinds of data which can be processed by PC 100, and a mail server function of transmitting and receiving email. It is noted that server 200 is not requisite for image forming system 500.

Server 200 includes a control unit 201 and a storage device 211. Control unit 201 has a CPU 203 and a memory 205. Memory 205 is a RAM which functions as a main storage device. Server 200 is communicatively connected to a network.

Storage device 211 is an auxiliary storage device such as a HDD. Storage device 211 may store various control programs 221a to be executed in control unit 201, various databases, and other various data (for example, data about a user who uses PC 100 or MFP 1). Control programs 221a include a database management program for operating a database.

Control unit 201 communicates with MFP 1 and PC 100 to transmit data stored in storage device 211 in accordance with their requests, and also receive data transmitted therefrom and store the received data in storage device 211 or the like.

### [Operations of Image Forming System 500 According to First Embodiment]

In image forming system 500 according to the present embodiment, in the case where a user uses PC 100 to cause one of MFPs 1 to execute a print job, the user is able to know in advance how much power will be consumed, for each MFP 1, if the print job is performed thereby. This function is implemented through cooperation of MFPs 1 and PC 100.

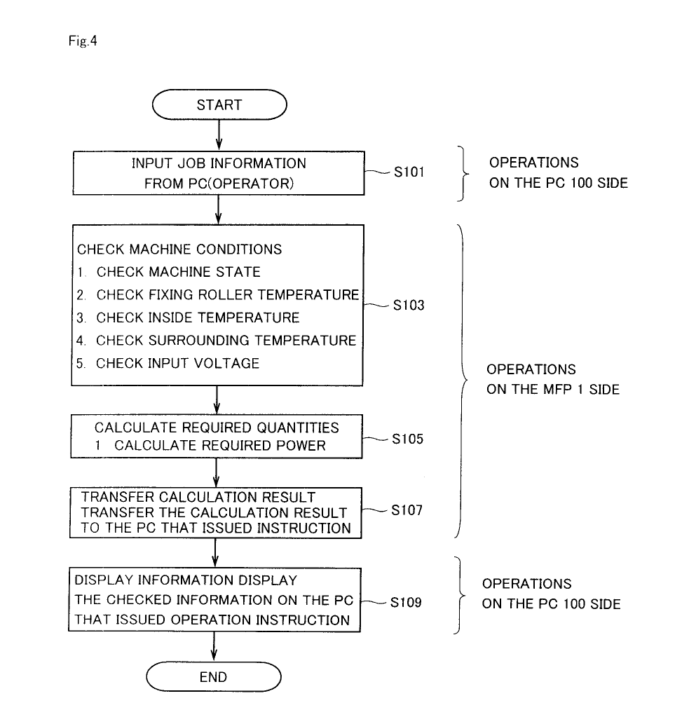

FIG. 4 is a flowchart illustrating the operations performed in image forming system 500.

Referring to FIG. 4, in step S101, a user (an operator) inputs information on a print job into PC 100 in order to form an image. The input is performed e.g. via a printer driver which is driven in PC 100. At this point in time, it is not decided yet which MFP 1 will be used for the print job. Control unit 101 in PC 100 communicates with each MFP 1 to transmit the information on the print job thereto. The information transmitted at this time includes, e.g., the number of pages to be printed, color printing or black-and-white printing, duplex printing or simplex printing, and other information about the print job. Each MFP 1 receives in communication unit 80 the information on the print job transmitted from PC 100. CPU 71 in each MFP 1 recognizes the content of the print job on the basis of the information received.

In step S103, CPU 71 in MFP 1 checks machine conditions of that MFP 1. At this time, CPU 71 checks and obtains information about the following conditions: the operating state (the machine state) of MFP 1; the temperature of heat roller 61 (the fixing roller temperature); the temperature inside MFP 1 (the inside temperature); the temperature around MFP 1 (the surrounding temperature); and the input voltage. It is noted that the operating state is determined by CPU 71. Further, CPU 71 may check and obtain information about only some of the above-described conditions. For example, CPU 71 may check and obtain the information on only the operating state of MFP 1 and the temperature of heat roller 61.

In step S105, CPU 71 calculates required quantities on the basis of the machine conditions checked in MFP 1 and the information on the print job received from PC 100. In other words, CPU 71 calculates the required quantities on the basis of parameters on the MFP 1 side and parameters regarding the content of the print job. In the present embodiment, CPU 71 calculates power consumption (required power) that will be required in the case where the print job is executed in that MFP 1. The way of calculating the required power will be described later.

In step S107, CPU 71 outputs the calculation result as output information. In the present embodiment, CPU 71 transmits (transfers) the calculation result, via communication unit 80, to PC 100 in which the job operation was issued, or from which the information on the print job was transmitted. The calculation result transmitted at this time includes information on the required power that was obtained through calculation.

In step S109, control unit 101 in PC 100 acquires the calculation result, i.e. the information on the required power, transmitted from each MFP 1. Control unit 101 displays information on display device 113 on the basis of the calculation results transmitted from the respective MFPs 1. At this time, control unit 101 displays the required power calculated in each MFP 1 on display device 113 so that the user can check it. In other words, each MFP 1 can provide, on display device 113, a display based on the calculation result. The content displayed on display device 113 at this time will be described later.

The above-described operations performed by MFPs 1 and PC 100 allow a user, when printing a document or the like, to check the content displayed on display device 113 to see how much power will be required in each MFP 1. As a result, the user can select one of MFPs 1 where the print job is to be executed, taking into consideration the required power in each MFP 1.

It is noted that in the above-described operations, each MFP 1 is able to perform the calculation and transmission of the required power without changing its operating state. For example, in the case where MFP 1 in a sleep state has received information on a print job from PC 100, MFP 1 calculates the required power and transmits the calculation result to PC 100 while remaining in the sleep state, rather than entering an operative state. As such, up to the stage where the required power is displayed on display device 113, MFP 1 does not initiate a printing operation, which suppresses unwanted power consumption.

### [Method for Calculating Required Power]

A method for calculating required power in each MFP 1 will now be described by giving an example. MFP 1 has a required power calculation table for use in calculating the required power. The required power calculation table shows how much power will be consumed to complete a print job if the print job is performed in that MFP 1, in accordance with the parameters on the MFP 1 side and the parameters regarding the content of the print job. The required power calculation table may be created, for example, by measuring in advance the amount of power consumed when a print job is actually performed in that MFP 1 under various conditions. The required power calculation table is stored in memory portion 73 in control unit 70, for example. CPU 71 in control unit 70 refers to the required power calculation table to calculate the required power.

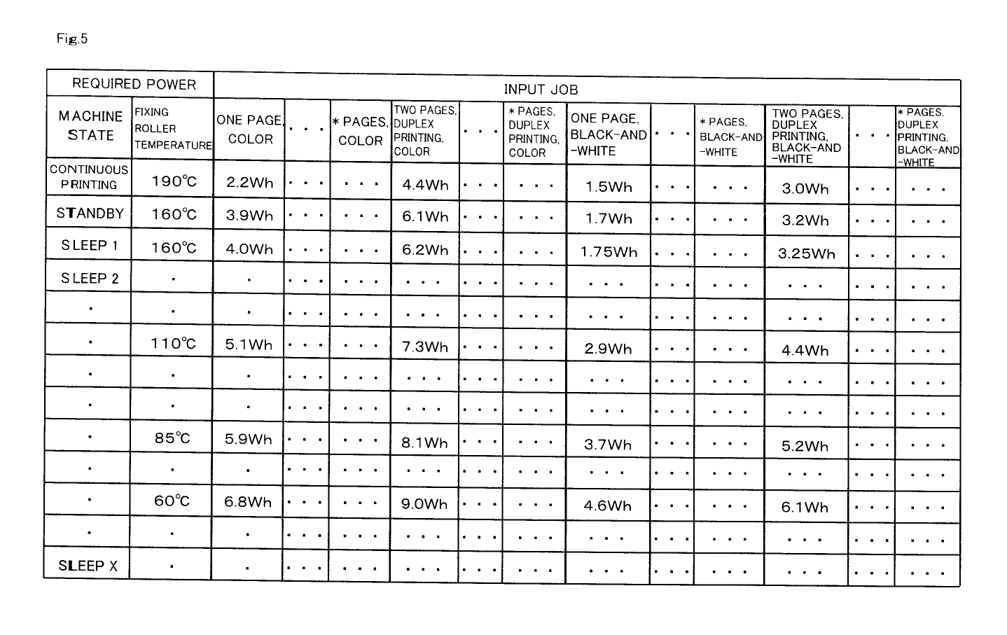

FIG. 5 shows an example of the required power calculation table.

Assume, for example, that the operating state of MFP 1 and the fixing roller temperature are used as the above-described machine conditions, or, the parameters on the MFP 1 side. In this case, in the required power calculation table, the required power is set in accordance with the operating state (or, the machine state) of MFP 1 and the fixing roller temperature. Here, the operating states of MFP 1 may include: a continuous printing state, a standby state, and sleep X states (X=1, 2, 3, . . . ), where the sleep X states are set in correspondence with different fixing roller temperatures so that the sleep state is classified into a plurality of states in accordance with the temperature of the fixing roller.

Furthermore, in the required power calculation table, the required power is set in accordance with the parameters regarding the content of the print job. The parameters regarding the content of the print job correspond to the manner of image formation that is performed for an input print job. The manner of image formation is determined in accordance with, e.g., the total number of pages to be output, duplex printing or simplex printing, and color printing or black-and-white printing.

CPU 71 is able to refer to this required power calculation table to calculate the required power on the basis of the operating state of MFP 1, the fixing roller temperature, and the input print job. For example, assume that a print job of color-printing one page on one sheet of paper is to be performed when MFP 1 is in the sleep state and the fixing roller is at a temperature of 110° C. In this case, CPU 71 calculates that the required power is 5.1 W/h.

In general, the fixing roller temperature is lower in the sleep state than in the continuous printing state or the standby state. The power consumed when a print job is performed subsequently is greater in the sleep state than in the continuous printing state or the standby state. Further, the amount of power consumption is greater as the fixing roller temperature is lower, or as the number of pages to be printed is greater. Moreover, the amount of power consumption is greater in color printing than in black-and-white printing.

As such, in the present embodiment, the required power calculation table uses, as one of the parameters on the MFP 1 side, the fixing roller temperature that will most greatly affect the power consumption.

It is noted that, in addition to the operating state of MFP 1 and the fixing roller temperature, the surrounding temperature of MFP 1 and/or the inside temperature of MFP 1, which may also affect the power consumption, may be used as the parameters on the MFP 1 side. This leads to an improved accuracy of the required power calculated by CPU 71. Furthermore, in addition to the fixing roller temperature and the surrounding and inside temperatures of MFP 1, the input voltage of MFP 1 may also be used as the parameter on the MFP 1 side in creating the required power calculation table. Generally, the efficiency of a halogen lamp used for fixing unit 60 with respect to the input voltage decreases as the input voltage decreases. Accordingly, the input voltage of MFP 1 will also affect the power consumption.

It is noted that, in calculating the required power, the fixing roller temperature alone may be used as the parameter on the MFP 1 side, without taking into consideration the operating state of MFP 1.

Increasing the number of parameters used for calculating the required power is expected to improve the accuracy in calculation of the power consumption. However, it is also expected that a mass-storage memory device 73 will be necessary for CPU 71 to perform the calculation. Accordingly, it is desirable that the parameters to be used are set as appropriate in consideration of the accuracy of required power to be calculated and the cost for manufacturing MFP 1.

Furthermore, the calculation of required power may be performed without using the required power calculation table as described above. For example, a formula which simulates the relationship between a value of each parameter and required power may be stored in memory portion 73 or the like in advance. In this case, CPU 71 can use the simulation formula to calculate required power in accordance with the temperature of the fixing roller in MFP 1, the content of the print job, and the like. Storing the simulation formula having a relatively small data amount in memory portion 73, instead of the required power calculation table having a relatively large data amount, can free up much disk space in memory portion 73.

### [Content Displayed on Display Device 113 According to First Embodiment]

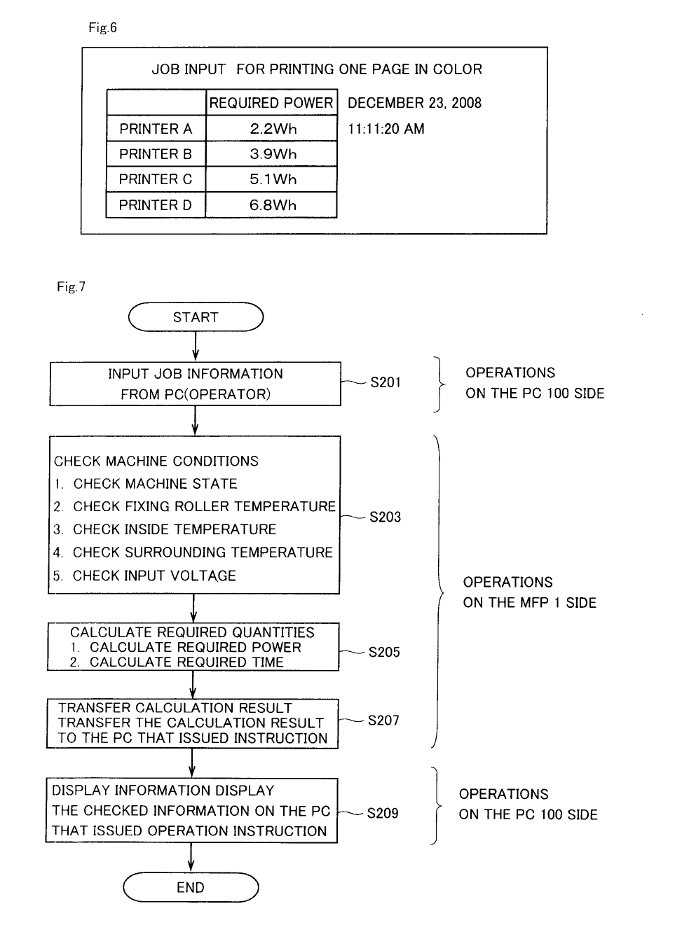

FIG. 6 shows an example of the content displayed on display portion 113 in PC 100.

In the following description, it is assumed that four MFPs 1 (hereinafter, these MFPs 1 may be called printers A to D distinguishably) are available for PC 100 via a network. When control unit 101 receives the information on the required power calculated in and transmitted from each MFP 1 as described above, control unit 101 displays the information on display device 113 so as to be recognizable by a user.

Referring to FIG. 6, control unit 101 displays the information on the required power in the form of a table. For example, in the case where a user instructs PC 100 to color-print a page on a sheet of paper, information on the required power for the print job is transmitted from each MFP 1. Control unit 101 displays the received information on the required power for printers A to D by arranging them in this order. FIG. 6 indicates that the required power in printer A is 2.2 W/h, the required power in printer B is 3.9 W/h, the required power in printer C is 5.1 W/h, and the required power in printer D is 6.8 W/h. The user can check the display to see how much power is expected to be consumed in each MFP 1.

In addition to the above information, control unit 101 displays, for example, the time when the information was received from each MFP 1, or the time when the display is provided. While the state of each MFP 1 varies with time, such display of the time allows the user to know that the information being displayed is only the information at that moment of time.

In the case where the display as described above is provided, the user can select printer A having the least required power and instruct the same to execute the print job. As a result, the print job is transmitted from the printer driver operating on PC 100 to printer A, where the print job is executed.

It is noted that the user may select a desired MFP 1 taking into consideration, not only the information on the required power in each MFP 1 being displayed, but also other factors including the location of each MFP 1. In any event, the user is able to select MFP 1 where the print job is to be executed in consideration of the required power.

As described above, according to the present embodiment, information on power consumption that will be required for executing a print job is output from MFP 1. This information on the required power is calculated on the basis of not only the operating state of MFP 1 but also the temperature of fixing unit 60 which would largely affect the power consumption, so that the resultant information has a relatively high accuracy. This provides the user with relatively detailed information about how much power will be consumed when a print job is executed in each MFP 1, before the user issues an instruction to execute the print job. As a result, the user is able to select MFP 1 to be used for printing in accordance with the states of the respective MFPs 1, so that power saving can be promoted more effectively.

### Second Embodiment

MFP 1, PC 100, server 200, and image forming system 500 including those components according to a second embodiment of the present invention have fundamental configurations similar to those of the first embodiment, and thus, description thereof will not be repeated here. The second embodiment differs from the first embodiment in that each MFP 1 calculates time required for executing a print job, in addition to the power consumption required for executing the print job.

### [Operations of Image Forming System 500 According to Second Embodiment]

FIG. 7 is a flowchart illustrating the operations performed in image forming system 500 according to the second embodiment.

In FIG. 7, steps S201 and S203 are identical to steps S101 and S103 in the first embodiment. Specifically, on the basis of an input operation by a user (an operator) into PC 100, control unit 101 in PC 100 transmits information on a print job to each MFP 1 (S201). CPU 71 in each MFP 1, on receipt of the information from PC 100, checks the machine conditions of that MFP 1 (S203).

In step S205, CPU 71 calculates required quantities on the basis of the machine conditions checked in MFP 1 and the information on the print job received from PC 100. At this time, CPU 71 calculates power consumption (required power) that will be required in the case where the print job is performed in that MFP 1, as in step S105 in the first embodiment. The way of calculating the required power is the same as in the first embodiment.

Here, in the second embodiment, CPU 71 further calculates time (required time) that will be required until completion of the print job in the case where the print job is executed in that MFP 1. The way of calculating the required time will be described later.

Steps S207 and S209 are identical to steps S107 and S109 in the first embodiment. Specifically, CPU 71 outputs the calculation result to PC 100 (S207). At this time, information regarding the required power and information regarding the required time are transmitted as the calculation result. Control unit 101 in PC 100 displays information on display device 113 on the basis of the calculation result transmitted from each MFP 1 (S209). The content displayed on display device 113 at this time will be described later.

### [Method for Calculating Required Time]

Hereinafter, a method for calculating required time in each MFP 1 will be described by giving an example. MFP 1 has a required time calculation table for use in calculating the required time, similarly as the required power calculation table for use in calculating the required power. The required time calculation table shows how long it will take to complete a print job if the print job is executed in that MFP 1, in accordance with the parameters on the MFP 1 side and the parameters regarding the content of the print job. The required time calculation table may be created, for example, by measuring in advance the time taken when a print job is actually performed in that MFP 1 under various conditions. The required time calculation table is stored in memory portion 73 in control unit 70, for example. CPU 71 in control unit 70 refers to the required time calculation table to calculate the required time.

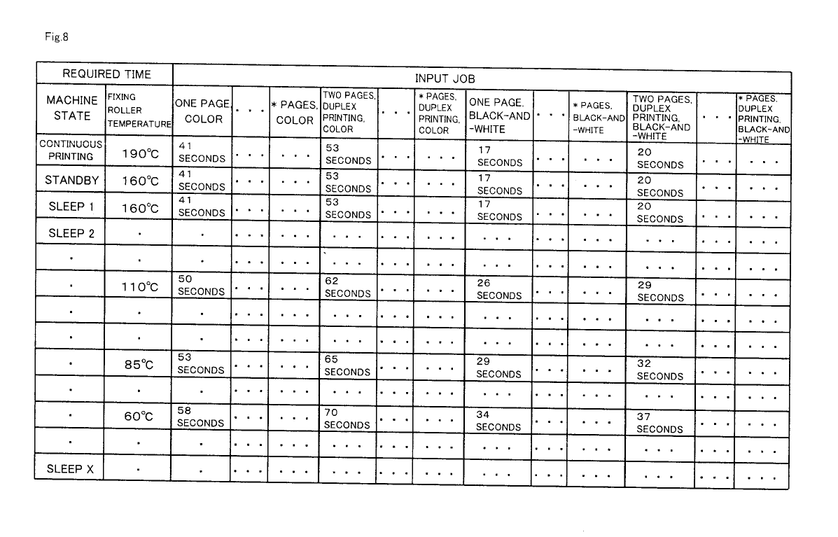

FIG. 8 shows an example of the required time calculation table.

Assume, for example, that the operating state of MFP 1 and the fixing roller temperature are used as the above-described machine conditions, or, the parameters on the MFP 1 side. In this case, in the required time calculation table, the required time is set in accordance with the operating state (or, the machine state) of MFP 1 and the fixing roller temperature. Here, the operating states of MFP 1 may include: a continuous printing state, a standby state, and sleep X states (X=1, 2, 3, . . . ), which are identical to those described above in conjunction with the required power calculation table in the first embodiment.

Furthermore, in the required time calculation table, the required time is set in accordance with the parameters regarding the content of the print job. The parameters regarding the content of the print job correspond to the manner of image formation that is performed for an input print job, as described above in conjunction with the required power calculation table in the first embodiment.

CPU 71 is able to refer to this required time calculation table to calculate the required time on the basis of the operating state of MFP 1, the fixing roller temperature, and the input information on the print job. For example, assume that a print job of color-printing one page on one sheet of paper is to be performed when MFP 1 is in the sleep state and the fixing roller is at a temperature of 110° C. In this case, CPU 71 refers to the required time corresponding to these parameters in the required time calculation table, to calculate that the required time is 50 seconds. It is noted that CPU 71 also refers to the required power calculation table, to calculate that the required power is 5.1 W/h (see FIG. 5).

In general, the fixing roller temperature is lower in the sleep state than in the standby state. Therefore, the time required until a print job can be started subsequently is longer in the sleep state, resulting in a longer required time. Further, the required time is longer as the fixing roller temperature is lower, or as the number of pages to be printed is greater. Moreover, the required time is longer in color printing than in black-and-white printing.

In the continuous printing state, execution of the print job that the user has instructed is started only after the print job that is currently in progress or that is on the queue has been finished. In the continuous printing state, CPU 71 calculates time required until when MFP 1 becomes ready to perform the print job accepted next. This time can be calculated on the basis of the information about the number of remaining pages on the currently performed print job, and other information. The required time can then be calculated on the basis of that calculated time, enabling the required time to be calculated more accurately. For example, assume that time required for performing a print job of color-printing one page on one sheet is 41 seconds. At this time, in the case where the time remaining until completion of the currently performed print job is 60 seconds, the required time is their total time of 101 seconds.

In the required time calculation table, similarly as in the required power calculation table, the fixing roller temperature is used as one of the parameters on the MFP 1 side, because the fixing roller temperature affects the time required for performing a print job. This enables more detailed calculation of required time.

It is noted that, in addition to the above parameters, the surrounding temperature of MFP 1 and/or the inside temperature of MFP 1 may be used as the parameters on the MFP 1 side. Furthermore, the input voltage of MFP 1 may also be used as one of the parameters in creating the required time calculation table. This can improve the accuracy of the required time calculated by CPU 71. Increasing the number of parameters used for calculating the required time is expected to improve the accuracy in calculation of the required time. However, it is also expected that a mass-storage memory device 73 will be necessary for CPU 71 to perform the calculation. Accordingly, it is desirable that the parameters to be used are set as appropriate in consideration of a desired accuracy of the required time to be calculated and the cost for manufacturing MFP 1.

Furthermore, the calculation of required time may be performed without using the required time calculation table as described above. For example, instead of the required time calculation table having a relatively large data amount, a simulation formula may be used to calculate the required time from various parameters, as in the case of calculating the required power described above. Storing the simulation formula having a relatively small data amount in memory portion 73 can free up much disk space in memory portion 73.

### [Content Displayed on Display Device 113 According to Second Embodiment]

FIG. 9 shows an example of the content displayed on display portion 113 according to the second embodiment.

Referring to FIG. 9, in the second embodiment, similarly as in the first embodiment, control unit 101 displays the information received from each MFP 1 on display device 113 so as to be recognizable by a user. In the second embodiment, in addition to the content displayed in the first embodiment, the required time calculated in each MFP 1 and transmitted to PC 100 is displayed as well.

Referring to FIG. 9, control 101 displays the received information on the required power and the required time for printers A to D in this order in the form of a table. For example, assume that a user instructs PC 100 to perform a print job of color-printing one page on one sheet of paper. In this case, the information on the required power and the required time for that print job is transmitted from each MFP 1. On receipt of the information, control unit 101 displays the table on display device 113 on the basis of the received information. The user can check the display to see how much power will be consumed and how long it will take to complete the print job in each MFP 1.

Specifically, the required power in each printer A to D is displayed on the column of “required power” and the required time is displayed on the column of “time required for job”. More specifically, FIG. 9 indicates that the required power and the required time are 2.2 W/h and 120 seconds for printer A, 3.9 W/h and 41 seconds for printer B, 5.1 W/h and 50 seconds for printer C, and 6.8 W/h and 58 seconds for printer D. Here, printer A is in the continuous printing state, so that the power that is expected to be consumed in the print job about to be performed is small. However, the print job about to be performed is initiated only after the current print job is finished, resulting in a longer required time.

Control unit 101 displays, in addition to the above information, for example the time when the information was received from each MFP 1, to clearly indicate that what is being displayed is the information at that moment of time.

In the case where the display as described above is provided, the user can select one of the printers where the print job is to be executed, in accordance with the circumstances of the user. For example, the user may select printer A having the least required power, or may select printer B requiring the least time, although the required power is not the least. As a result, an instruction to execute the print job is transmitted from the printer driver operating on PC 100 to the printer selected by the user, where the print job is executed.

It may be configured such that the user is able to select a desired MFP 1 taking into consideration the location of each MFP 1 and other factors as well.

As described above, according to the second embodiment, MFP 1 is able to calculate the required power and the required time in detail. The required power on and the required time calculated in each MFP 1 are displayed on display device 113. This allows a user to select MFP 1 to be used for executing the print job in accordance with the power that is expected to be consumed and the time that is expected to be taken for that print job in each MFP 1, and also in consideration of how urgent the print job should be done, how much power should be saved, and other conditions. This enhances the usability of MFP 1, and further promotes effective power saving.

### Third Embodiment

MFP 1, PC 100, server 200, and image forming system 500 including those components according to a third embodiment of the present invention have fundamental configurations similar to those of the second embodiment, and thus, description thereof will not be repeated here. The third embodiment differs from the second embodiment in that control unit 101 in PC 100 has a function of selecting MFP 1 that is suitable for execution of a print job, in accordance with the required power and the required time calculated in each MFP 1.

In determining MFP 1 that is suitable for use in printing, control unit 101 refers to information regarding a preset priority mode (an example of a printing condition), as will be described later. The information regarding the priority mode is set by a user, for example, and stored in storage device 111. The priority mode may include a power saving priority mode (a power consumption condition) in which a priority is given to less power consumed for execution of a print job. The priority mode may also include a productivity priority mode (a completion time condition) in which a priority is given to shorter or shortest time taken for completion of the print job.

### [Operations of PC 100 According to Third Embodiment]

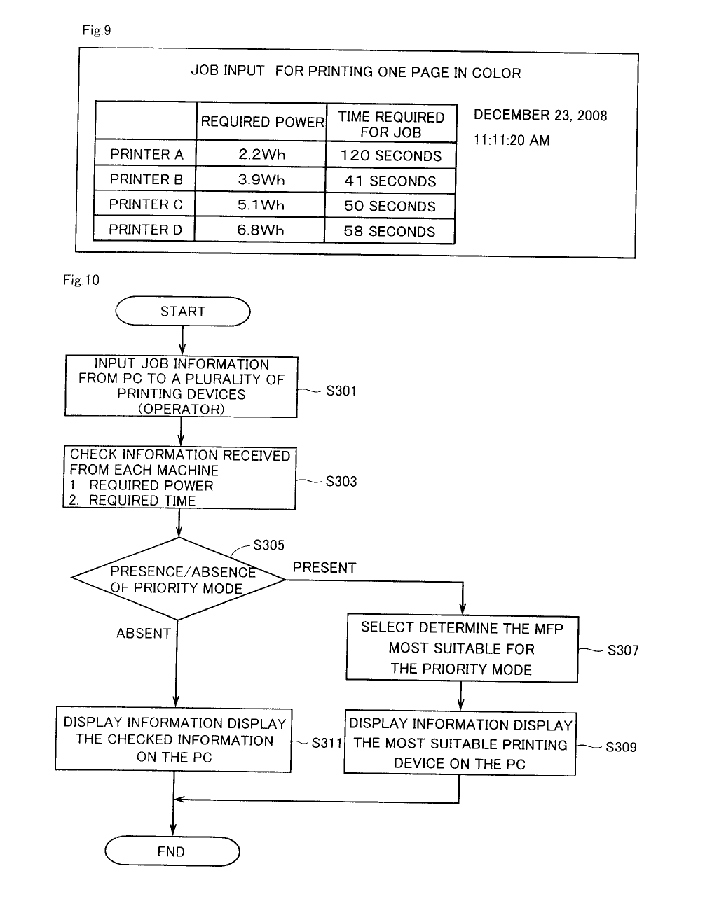

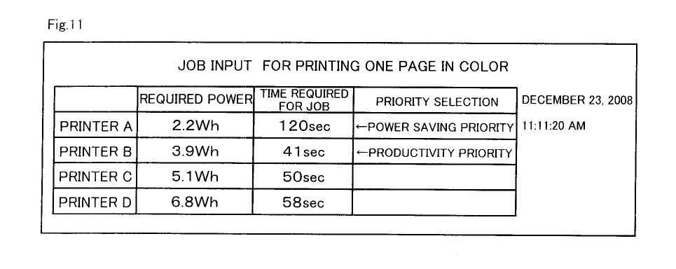

FIG. 10 is a flowchart illustrating the operations of PC 100 according to the third embodiment.

Referring to FIG. 10, step S301 is similar to step S101 in the first embodiment. Specifically, control unit 101, in response to an input operation by a user (an operator) into PC 100, communicates with each MFP 1 to transmit thereto the information about a print job that is to be executed in one of MFPs 1.

In step S303, control unit 101 receives and checks the information returned from each MFP 1. In the third embodiment, the information on the required power and the required time, calculated similarly as in the second embodiment, is transmitted from each MFP 1.

In step S305, control unit 101 determines whether a priority mode has been set in PC 100.

If it is determined in step S305 that the priority mode has been set (i.e. the priority mode is “present”), in step S307, control unit 101 determines, for the priority mode that has been set, which one of MFPs 1 is most suitable for use in printing. In the case where two or more priority modes have been set, control unit 101 makes the above determination for each priority mode.

In step S309, control unit 101 displays, on display device 113, the information on the required power and the required time received from each MFP 1, as well as the information about which one of MFPs 1 is most suitable for use in printing for each priority mode. In other words, control unit 101 displays the above-described information on display device 113 so as to encourage the user to select that MFP 1 for executing the printing. The content displayed at this time will be described later.

On the other hand, if it is determined in step S305 that no priority mode has been set (i.e. the priority mode is “absent”), in step S311, control unit 101 displays, on display device 113, the information on the required power and the required time received from each MFP 1. The display provided at this time is for example similar to that provided in the second embodiment.

When the display is provided in step S309 or S311, the user can select MFP 1 where the print job is to be executed on the basis of that display. When an operation to select MFP 1 is performed by the user, control unit 101 causes that MFP 1 to execute the print job.

### [Content Displayed on Display Device 113 According to Third Embodiment]

FIG. 11 shows an example of the content displayed on display portion 113 according to the third embodiment in the case where priority modes have been set.

Referring to FIG. 11, in the third embodiment as well, control unit 101 displays the information on the required power and the required time received from each MFP 1 on display device 113 so as to be recognizable by a user, as in the second embodiment. Here, in the case where one or more priority modes have been set in PC 100, control unit 101 further displays, for MFP 1 which was determined to be most suitable for use in printing for each priority mode, the information to that effect.

For example, the following case will be assumed and the content of display in that case will be described. Assume that the power saving priority mode and the productivity priority mode as described above are set as the priority modes. Further, assume that, on the basis of the information on the required power and the required time received from each MFP 1, MFP 1 having the least required power is printer A, and MFP 1 having the least required time is printer B.

In this case, as shown in FIG. 11, control unit 101 provides and displays a “priority selection” column, in addition to the “required power” column and the “required time” column, for each MFP 1. Here, in the “priority selection” column, information to the effect that the corresponding MFP 1 is suitable for use in printing for a certain priority mode is displayed.

Control unit 101 displays the required power and the required time for each MFP 1. In addition, control unit 101 displays, in the “priority selection” column, “power saving priority” for printer A, and “productivity priority” for printer B. That is, control unit 101 selects printer A and printer B, for the respective priority modes, as MFP 1 that is suitable for executing the print job. This allows the user, by referring to the indications in the “priority selection” column, to select printer A indicated as “power saving priority” to cause it to execute the print job, to thereby reduce the power consumed by execution of the print job. Alternatively, the user may select printer B indicated as “productivity priority” to cause it to execute the print job, to thereby finish the print job in the shortest possible time.

As described above, according to the third embodiment, in the case where a priority mode has been set, display device 113 displays MFP 1 that is most suitable for executing the printing for that priority mode. Specifically, in addition to the information on the required power and the required time, the information indicating which one of MFPs 1 meets the priority requirement wished by the user, such as power saving requirement or productivity requirement, is displayed for the user. This allows the user to select that MFP 1 for performing the printing, and as a result, MFP 1 suitable for executing the print job can be selected. In other words, the user no longer needs to perform the operation of comparing the required power and the required time for one MFP 1 with those for another MFP 1 to determine a suitable MFP 1 by the user him/herself. The user is able to select a suitable MFP 1 with ease and without error.

It may be configured such that the user can set conditions for selecting MFP 1 as appropriate to thereby set a desired priority mode.

### Effects of Embodiments

In the image forming system configured as described above, a user can recognize, at a glance, that the required power in each MFP differs in accordance with the state of each MFP. Further, the user is able to select one of the MFPs for use in executing a print job, taking into consideration the required power when the print job will be executed in each MFP. Accordingly, by designating the MFP in which power consumption is expected to be small as the one to execute the print job, power saving can be promoted effectively.

Furthermore, the power consumption that is expected when a print job is executed in each MFP is displayed on a PC operated by the user in the form of a table. This allows the user to readily confirm the content of display. As a result, the user can readily determine which one of the MFPs should be selected for execution of the print job.

### [Others]

It is noted that the image forming system may be configured by combining any of the above-described embodiments.

In the first or second embodiment, the control unit in the PC may be configured such that, while it displays the required power and other information as described above, it automatically selects an MFP where the print job is to be executed, in accordance with a preset selecting condition, and causes the selected MFP to execute the print job. In this case, the control unit may select one of the MFPs for executing a print job in accordance with the degree of matching of each MFP with a preset condition. For example, the control unit may select the MFP that will consume least power for executing the print job. Furthermore, the control unit may automatically select an MFP for executing a print job in accordance with a preset selection condition or in accordance with a priority mode and cause the selected MFP to execute the print job, without providing the display of the required power as described above. Moreover, in the third embodiment, the control unit in the PC may be configured to automatically select an MFP that is recommended for a preselected one of the priority modes as the MFP in which the print job is to be executed, and cause the selected MFP to perform printing. In these cases, the user no longer needs to perform the operation of selecting an MFP to cause the MFP to execute the print job, whereby the operation load of the user can be reduced.

Further, the image forming system may be configured to store information obtained from each MFP in a server, in which case the PC may be configured to communicate with the server so as to calculate the required power in each MFP and the like. In this case, one of the MFPs may function as the server.

For example, the server may receive information about a print job from the PC and transmit the information to each MFP. The server may receive information from each MFP and transmit the information to the PC. As such, the server may relay information between the PC and each MFP. In this case, even in the case where there is a change in network configuration in the image forming system, such as an increase or decrease in number of the PC or MFPs, it is only necessary to perform settings for the communications between the PC and the server and between the server and the MFPs, whereby the modification and/or maintenance of the system configuration can readily be performed. Furthermore, the communication between each PC and each MFP can be decreased, whereby the network load can be reduced.

It may also be configured such that the information on the fixing roller temperature and the operating state in each MFP, for example, is transmitted to the server as appropriate. At this time, the server may be configured such that when it receives information on a print job from the PC, it calculates required power and others for each MFP and transmit the calculation result to the PC. It is noted that a required power calculation table and others for each MFP may be set in advance in the server. Using such a configuration can reduce the network load as described above, and moreover, the load for calculating the required power and others in each MFP can be saved, and the cost for manufacturing the MFP can also be reduced.

Furthermore, the image forming system may be configured such that, when a user operates one of the MFPs, the information on the required power in that MFP and in each of the other MFPs is transmitted to that MFP. In this case, the control unit in the MFP being operated by the user may display the received required power for each MFP for example on a display panel provided in that MFP (an example of an output). Specifically, for example in the case where a user performs an input operation for a print job such as copying, the information on the required power and others for each MFP is displayed on the display panel. This allows the user to select one of the MFPs that will consume less power as the location where the print job is to be executed.

In the image forming system, in the case where only one MFP is connected to the network, the display of the required power as described above may or may not be provided.

Further, in the case where a user performs an input operation for a print job into an MFP, a control unit in that MFP may calculate required power and others in that MFP for that print job and display the calculation result on a display panel in that MFP.

Furthermore, the image forming device may be any of a black-and-white or color copier, a printer, a facsimile machine, or a composite machine thereof (MFP).

The image processing device may be, besides the PC, any of various devices capable of transmitting a print job. In the image forming system, one of the plurality of MFPs may function as an image processing device that transmits a print job to the other MFPs.

The processing described in the above embodiments may be performed by software or by using a hardware circuit.

Moreover, a program for executing the processing described in the above embodiments may be provided, in which case the program may be recorded on a recording medium such as a CD-ROM, a flexible disk, a hard disk, a ROM, a RAM, or a memory card, which may be provided to the user. The program may also be downloaded to the device via a communication line such as the Internet. The processing described in the above flowcharts is executed by a CPU and the like in accordance with the program.

According to the above embodiments, information on power consumption that will be required for executing a print job, calculated on the basis of a temperature of a fixing device, is output from the image forming device, to allow a user to know relatively detailed power consumption that is expected when the print job will be performed in that image forming device. Accordingly, it is possible to provide an image forming system that enables one of a plurality of image forming devices to be selected for use in printing in accordance with the states of the respective image forming devices, to promote power saving effectively.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image forming system comprising a plurality of image forming devices and an image processing device,
each of said plurality of image forming devices having a heat fixing function using a fixing device, and including
a first detecting unit configured to detect a temperature of said fixing device,
a recognizing unit configured to recognize an acceptable print job,
a calculating unit configured to calculate power consumption that will be required for executing the print job recognized by said recognizing unit on the basis of the temperature detected by said first detecting unit, and
an output unit configured to perform an output of output information in accordance with a calculation result by said calculating unit,
said image processing device causing an image forming device to execute a print job, and including
an acquiring unit configured to acquire information on power consumption that will be required for executing said print job in each of said plurality of image forming devices with which said image processing device is communicable, and
a selecting unit configured to select the image forming device that is suitable for executing the print job on the basis of the information on the power consumption acquired by said acquiring unit,
said image processing device causing the image forming device selected by said selecting unit from among said plurality of image forming devices to execute the print job.

2. The image forming system according to claim 1, further comprising a management device capable of communicating with each of said plurality of image forming devices, wherein
said management device includes
a receiving unit configured to receive the output information from each of said plurality of image forming devices, and
a storing unit configured to store the output information received by said receiving unit, and
said acquiring unit acquires the output information stored in said storing unit so as to acquire the information on the power consumption in each of said plurality of image forming devices.

3. The image forming system according to claim 1, wherein said calculating unit further calculates time required for completion of the print job recognized by said recognizing unit.

4. The image forming system according to claim 1, wherein
each of said plurality of image forming devices further includes a determining unit configured to determine an operating state, and
said calculating unit performs the calculation on the basis of the operating state determined by said determining unit.

5. The image forming system according to claim 1, wherein
each of said plurality of image forming devices further includes a second detecting unit configured to detect at least one of a surrounding temperature and an inside temperature, and
said calculating unit performs the calculation on the basis of the temperature detected by said second detecting unit.

6. The image forming system according to claim 1, wherein
each of said plurality of image forming devices further includes a third detecting unit configured to detect a voltage of a power source being input, and
said calculating unit performs the calculation on the basis of the voltage detected by said third detecting unit.

7. The image forming system according to claim 1, wherein
each of said plurality of image forming devices further includes a display unit configured to display information so as to be recognizable by a user, and
said output unit performs said output by providing a display based on said output information by said display unit.

8. The image forming system according to claim 1, wherein said output unit performs said output while the operating state is being maintained.

9. The image forming system according to claim 1, wherein
each of said plurality of image forming devices further includes a communication unit for communicating with an external device, and
said output unit performs said output by transmitting said output information to said external device by said communication unit.

10. The image forming system according to claim 9, wherein said communication unit performs the communication with said external device while the operating state is being maintained.

11. The image forming system according to claim 1, wherein said selecting unit performs said selection on the basis of a preset printing condition.

12. The image forming system according to claim 11, wherein
said printing condition includes at least one of
a power consumption condition in which a priority is given to less power consumed for execution of a print job, and
a completion time condition in which a priority is given to shorter time taken for completion of the print job.

13. The image forming system according to claim 1, wherein said image processing device further includes a display unit configured to provide a display based on the information acquired by said acquiring unit.

14. An image forming device having a heat fixing function using a fixing device, the image forming device comprising:
a first detecting unit configured to detect a temperature of said fixing device;
a recognizing unit configured to recognize a print job acceptable by said image forming device;
a calculating unit configured to calculate power consumption that will be required for executing the print job recognized by said recognizing unit on the basis of the temperature detected by said first detecting unit; and
an output unit configured to perform an output of output information in accordance with a calculation result by said calculating unit.

15. The image forming device according to claim 14, wherein said calculating unit further calculates time required for completion of the print job recognized by said recognizing unit.

16. The image forming device according to claim 14, further comprising a determining unit configured to determine an operating state of said image forming device, wherein
said calculating unit performs the calculation on the basis of the operating state of said image forming device determined by said determining unit.

17. The image forming device according to claim 14, further comprising a second detecting unit configured to detect at least one of a surrounding temperature and an inside temperature of said image forming device, wherein
said calculating unit performs the calculation on the basis of the temperature detected by said second detecting unit.

18. The image forming device according to claim 14, further comprising a third detecting unit configured to detect a voltage of a power source being input into said image forming device, wherein
said calculating unit performs the calculation on the basis of the voltage detected by said third detecting unit.

19. The image forming device according to claim 14, further comprising a display unit configured to display information so as to be recognizable by a user, wherein
said output unit performs said output by providing a display based on said output information by said display unit.

20. The image forming device according to claim 14, wherein said output unit performs said output while the operating state of said image forming device is being maintained.

21. The image forming device according to claim 14, further comprising a communication unit for communicating with an external device, wherein
said output unit performs said output by transmitting said output information to said external device by said communication unit.

22. The image forming device according to claim 21, wherein said communication unit performs the communication with said external device while the operating state of said image forming device is being maintained.

23. An image processing device causing an image forming device to execute a print job, the image processing device comprising:
an acquiring unit configured to acquire information on power consumption that will be required for executing said print job in each of a plurality of image forming devices with which the image processing device is communicable; and
a selecting unit configured to select the image forming device that is suitable for executing the print job on the basis of the information on the power consumption acquired by said acquiring unit.

24. The image processing device according to claim 23, wherein said selecting unit performs said selection on the basis of a preset printing condition.

25. The image processing device according to claim 24, wherein
said printing condition includes at least one of
a power consumption condition in which a priority is given to less power consumed for execution of a print job, and
a completion time condition in which a priority is given to shorter time taken for completion of the print job.

26. The image processing device according to claim 23, further comprising a display unit configured to provide a display based on the information acquired by said acquiring unit.

27. A method for controlling an image forming device having a heat fixing function using a fixing device, comprising the steps of:
detecting a temperature of said fixing device;
recognizing a print job acceptable by said image forming device;
calculating power consumption that will be required for executing the print job recognized in said recognizing step, on the basis of the temperature detected in said detecting step; and
outputting output information in accordance with a calculation result in said calculating step.

28. A method for controlling an image processing device, the image processing device causing an image forming device to execute a print job, the method comprising the steps of:
acquiring information on power consumption that will be required for executing said print job in each of a plurality of image forming devices with which the image processing device is communicable; and
selecting the image forming device that is suitable for executing the print job on the basis of the information on the power consumption acquired in said acquiring step.

29. A program for controlling an image forming device having a heat fixing function using a fixing device, the program being stored in a computer readable medium and causing a computer to execute processing comprising the steps of:
detecting a temperature of said fixing device;
recognizing a print job acceptable by said image forming device;
calculating power consumption that will be required for executing the print job recognized in said recognizing step, on the basis of the temperature detected in said detecting step; and
outputting output information in accordance with a calculation result in said calculating step.

30. A program for controlling an image processing device, the image processing device causing an image forming device to execute a print job, the program being stored in a computer readable medium and causing a computer to execute processing comprising the steps of:
acquiring information on power consumption that will be required for executing said print job in each of a plurality of image forming devices with which the image processing device is communicable; and
selecting the image forming device that is suitable for executing the print job on the basis of the information on the power consumption acquired in said acquiring step.
